(19) United States
(12) Patent Application Publication
(10) Pub. No.: US 2007/0279681 A1
(43) Pub. Date: Dec. 6, 2007

(54) Document data processing apparatus and recording medium

(75) Inventor: Kazuo Matoba, Akashi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/714,141

(22) Filed: Mar. 6, 2007

(30) Foreign Application Priority Data
May 30, 2006 (JP) 2006-150730

(51) Int. Cl. G06F 3/12

(52) U.S. Cl. 358/1.15; 358/403

(57) ABSTRACT

A document data processing apparatus, comprising: an attribute information acquirer that acquires attribute information of sender or recipient; a recommended information giver that gives recommended information to recommend an output operation to document data to be transmitted, based on said acquired attribute information; and a transmitter that transmits said document data carrying the given recommended information.

This application claims priority under 35 U.S.C. § 119 to Japanese Patent Application No. 2006-150730 filed on May 30, 2006, the entire disclosure of which is incorporated herein by reference in its entirety.

### BACKGROUND OF THE INVENTION

1. Field of the Invention

The present invention relates to a document data processing apparatus that is applied to an image forming apparatus, etc. having a document data sending or receiving function, and a recording medium having therein a recorded document data processing program to make a computer execute a predetermined document data process.

2. Description of the Related Art

The following description sets forth the inventor's knowledge of related art and problems therein and should not be construed as an admission of knowledge in the prior art.

In companies and other offices, a number of document data, etc. are distributed between users on a daily basis. Since a business document, etc. usually includes some key points that are rather limited, a recipient of document data preferentially browses the key points, which is enough in many cases. Therefore, every time document data is transmitted, a recipient of document data generally performs a manual operation to select or pick up key points therefrom to display them on a display or print them by a printer.

However, a manual operation to select or pick up key points is troublesome for the recipient. It is such a burden especially for users who handle many documents, which decreases efficiency in document processing.

According to conventional arts disclosed in Japanese Unexamined Laid-open Patent Publications No. 2000-90118 and No. 2000-90119, a user enters an interest concept, and then document data is analyzed to detect the location of the related description so that the concept can be reflected in printing.

Further, according to an art disclosed in Japanese Unexamined Laid-open Patent Publication No. 6-291779, original document data is created, and just a part of the original document data is picked up for each destination or other document data is added to the original document data, and then it is transmitted to multiple destinations.

However, in the above art in which a user enters a concept, it is still disadvantage that the user bothers to enter a concept about each piece of document data.

Further, in the above art in which just a part of original document data is picked up for each destination or other document data is added to the original document data, and then it is transmitted to multiple destinations, it is also still disadvantage that a sender bothers to perform an operation to select or add document data. In addition, a recipient of the document data has to perform a manual operation to select or pick up key points therefrom to display or print them.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

An object of the present invention is to provide a document data processing apparatus that does not require a sender to enter an interest concept about each piece of document data, perform an additional operation, etc.

Another object of the present invention is to provide a document data processing apparatus that enables a recipient of document data to output the document data by a print mode or a print condition that is set in advance without performing a manual operation to select or pick up key points, etc. therefrom about each piece of document data.

Still another object of the present invention is to provide a recording medium having therein a recorded document data processing program to make a computer execute a document data process in the document data processing apparatus.

A first aspect of the present invention is a document data processing apparatus, comprising:
an attribute information acquirer that acquires attribute information of sender or recipient;
a recommended information giver that gives recommended information to recommend an output operation to document data to be transmitted, based on said acquired attribute information; and
a transmitter that transmits said document data carrying the given recommended information.

A second aspect of the present invention is a document data processing apparatus, comprising:
an attribute information acquirer that acquires attribute information of document data to be transmitted;
a recommended information giver that gives recommended information to recommend an output operation to the document data to be transmitted, based on said acquired attribute information; and
a transmitter that transmits said document data carrying the given recommended information.

A third aspect of the present invention is a document data processing apparatus, comprising:
a receiver that receives document data carrying recommended information to recommend an output operation, and the recommended information is given based on attribute information of sender or recipient;
an output part that outputs said received document data; and
an output controller that controls an output operation performed by said output part, according to said recommended information given to the document data.

A fourth aspect of the present invention is a document data processing apparatus, comprising:
a receiver that receives document data carrying recommended information to recommend an output operation, and the recommended information is given based on attribute information of sender or recipient;
an output part that outputs said received document data; and
an output controller that controls an output operation performed by said output part, according to said recommended information given to the document data.

A fifth aspect of the present invention is a recording medium having therein a recorded document data processing program to make a computer execute:
acquiring attribute information of sender or recipient;
giving recommended information to recommend an output operation to document data to be transmitted, based on said acquired attribute information; and
transmitting said document data carrying the given recommended information.

A sixth aspect of the present invention is a recording medium having therein a recorded document data processing program to make a computer execute:
acquiring attribute information of document data to be transmitted;
giving recommended information to recommend an output operation to document data to be transmitted, based on said acquired attribute information; and
transmitting said document data carrying the given recommended information.

A seventh aspect of the present invention is a recording medium having therein a recorded document data processing program to make a computer execute:
receiving document data carrying recommended information to recommend an output operation, and the recommended information is given based on attribute information of sender or recipient;
outputting said received document data; and
controlling an output operation to output said document data, according to said recommended information given to the document data.

An eighth aspect of the present invention is a recording medium having therein a recorded document data processing program to make a computer execute:
receiving document data carrying recommended information to recommend an output operation, and the recommended information is given based on attribute information of document data;
outputting said received document data; and
controlling an output operation to output said document data, according to said recommended information given to the document data.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram showing a configuration of a document data processing apparatus according to one embodiment of the present invention;

FIG. 2 is a table showing examples of recommended information;

FIG. 3 is a drawing to explain forms in which recommended information is given to document data;

FIG. 4 is a table showing a form in which recommended information are recorded in a recommended information recorder;

FIG. 5 is a flowchart showing a procedure executed by the image data processing apparatus when document data is transmitted;

FIG. 6 is a part from a flowchart showing an example of a procedure executed by the document data processing apparatus when document data is transmitted;

FIG. 7 is a part from a flowchart showing another example of a procedure executed by the document data processing apparatus when document data is transmitted;

FIG. 8 is a part from a flowchart showing yet another example of a procedure executed by the document data processing apparatus when document data is transmitted;

FIG. 9 is a screen to select recommended information to give to document data;

FIG. 10 is a flowchart showing a procedure executed by the document data processing apparatus when document data is received;

FIG. 11 is a screen to select recommended information from those received;

FIG. 12 is a flowchart showing a procedure to register recommended information; and

FIG. 13 is a screen displayed when recommended information is registered.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

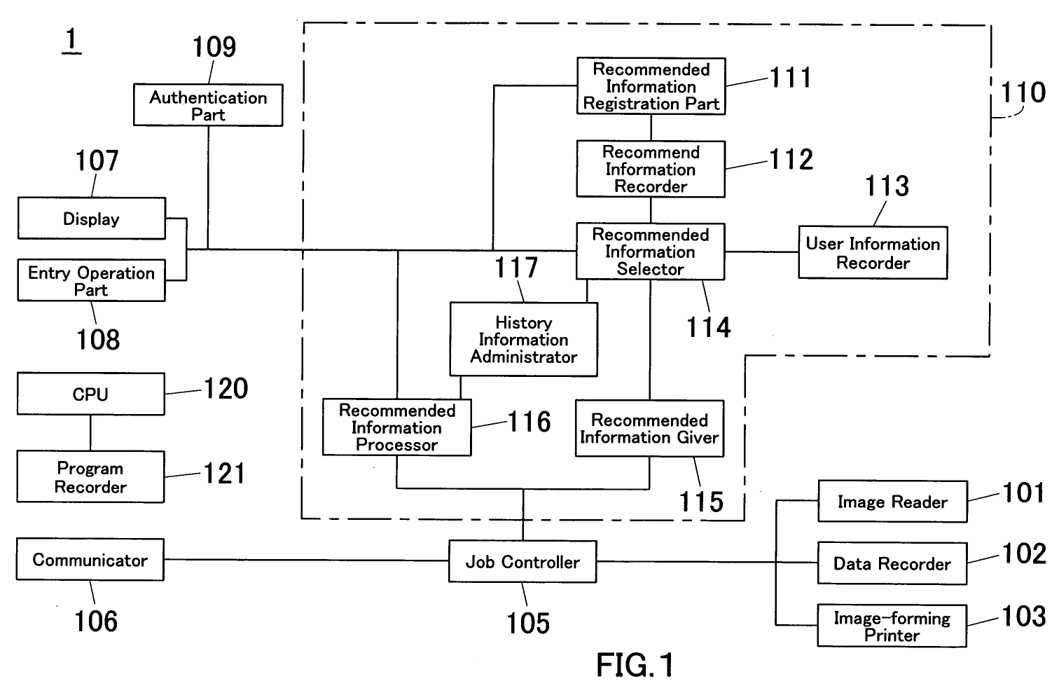

FIG. 1 is a functional block diagram showing a configuration of a document data processing apparatus according to one embodiment of the present invention. In this embodiment, a MFP (Multi Function Peripheral) that is a multifunctional image forming apparatus having functions such as copying, printing, facsimile and scanning, is used as a document data processing apparatus 1.

In FIG. 1, the document data processing apparatus 1 comprises an image reader 101, a data recorder 102, an image-forming printer 103, a job controller 105, a communicator 106, a display 107, an entry operation part 108, an authentication part 109, and a recommended information handler 110.

The Image reader 101 scans a document and convert it to image data, and the Data recorder 102 records document data that is image data read out by the Image reader 101 and print data transmitted from an external device, and other data.

The image-forming printer 103 prints document data read out by the Image reader 101 and transmitted from an external apparatus, and other data.

The job controller 105 controls job execution in the document data processing apparatus 1. For example: it makes the image-forming printer 102 print or makes the Data recorder 102 record document data read out by the Image reader 101; it makes the communicator 106 not only receive document data transmitted from an external device, but also transfer it to a recommended information processor 116 in the recommended information handler 110; and it makes the image-forming printer 103 output print data transferred from the recommended information processor 116. Further, it makes the communicator 106 not only transfer document data that is read out by the Image reader 101 or recorded in the Data recorder 102, to the recommended information giver 115, but also transmit the document data carrying recommended information given by the recommended information giver 105, to a predetermined destination.

Here, recommended information is to recommend an operation to output document data, in other words, it is an operation to display or print document data. Recommended information will be explained with concrete examples hereinafter.

The communicator 106 functions as an interface to exchange document data, etc. between the image processing apparatus 1 and external devices via a network, etc.

The display 107 comprises a liquid crystal panel for example, and displays status of the document data processing apparatus 1, set modes, recommended information, etc.

The entry operation part 108 is used to give various instructions and enter data, for example a user sets a mode and a destination and enters/selects recommended information, etc., using the entry operation part 108. It comprises key entry parts such as a numeric key pad, a start key, a stop key, etc., and a touch panel provided to the monitor of the display 107.

The authentication part 109 performs user authentication using identification information, authentication information such as password, etc. entered by a user from the entry operation part 108, when he/she uses the document data processing apparatus 1. If authentication succeeds, the user is permitted to use the document data processing apparatus 1, and if it does not succeed, he/she is prohibited to use it.

The recommended information handler 110 comprises a recommended information registration part 111, a recommended information recorder 112, a user information recorder 113, a recommended information selector 114, a recommended information giver 115, a recommended information processor 116, and a history information administrator 117.

The recommended information registration part 111 writes and registers in the recommended information recorder 112, recommended information entered by a user from the entry operation part 108, and overwrites and revises the registered recommended information according to a user instruction entered by a user from the entry operation part 108.

Further, the recommended information registration part 111 also checks whether or not there is in the recommended information recorder 112, the same recommended information as the one detected by the recommended information handler 116 (to be described hereinafter) when document data is received, and if there is not the same recommended information, it records and registers the detected one as new recommended information in the recommended information recorder 112. In this way, if there is not the same recommended information as received one in the recommended information recorder 112, it is always recorded therein as new recommended information, and then the amount of accumulated recommended information automatically increases without user operation to perform registration.

The recommended information recorder 112 records and accumulates recommended information and each of them is related to attribute information of user or document data.

The user information recorder 113 records attribute information of respective users, such as title, section, etc.

When a user transmits document data to a particular destination, the recommended information selector 114 acquires attribute information of sender user, recipient user and document data to be transmitted, and compares them to the attribute information of the respective recommended information recorded in the recommended information recorder 112; and then selects recommended information having corresponding (the same) attribute information of sender user, recipient user and document data. Further, if the recommended information selector 114 selects only one recommended information, the recommended information is displayed on the display 107 for user confirmation. If there are a plurality of recommended information having corresponding attribute information of sender user, recipient user and document data, the plurality of recommended information are displayed on the display 107 so that a user can select preferable recommended information via the entry operation part 108. An administrator of the apparatus can set the configuration in which the recommended information is displayed on the display 107 for user selection. However, if the configuration is not set and there are the plurality of corresponding recommended information, the recommended information selector 114 selects all of the plurality of recommended information.

Meanwhile, the document data to be transmitted can be document data read out by the Image reader 101 or recorded in the Data recorder 102. Further, a transmission method of the document data is not limited, and various transmission methods such as FTP, e-mail, SMPT, etc. can be used.

The recommended information giver 115 gives to the document data transferred from the job controller 105, the recommended information having corresponding attribute information of sender user, recipient user and document data, which is selected by the recommended information selector 114, and then returns it to the job controller 105. The job controller 105 transmits the returned document data carrying given recommended information to a specified destination via the communicator 106.

When the document data carrying given recommended information is transmitted from an external device, the recommended information processor 116 executes processes relating to recommended information. Specifically, if the document data received by the communicator 106 is transferred via the job controller 105 to the recommended information processor 116, the recommended information processor 116 detects the recommended information given to the document data, and then transfers the recommended information to the recommended information registration part 111, displays them on the display 107, and makes a user to select preferable one from the displayed recommended information. According to the user selection, the recommended information processor 116 performs on the document data a process specified in the recommended information, and transfers the document data to the display 107 to display or transfers to the image-forming printer 103 as print data.

The history information administrator 117 records and administers history information of the document data carrying given recommended information, which is received.

Meanwhile, the functions of the job controller 105, the recommended information registration part 111, the recommended information selector 114, the recommended information giver 115, the recommended information processor 116, etc., and a part of the functions of the history information administrator 117, which are previously described, are enabled by a CPU 120 that performs operations according to a program stored in a program recorder 121.

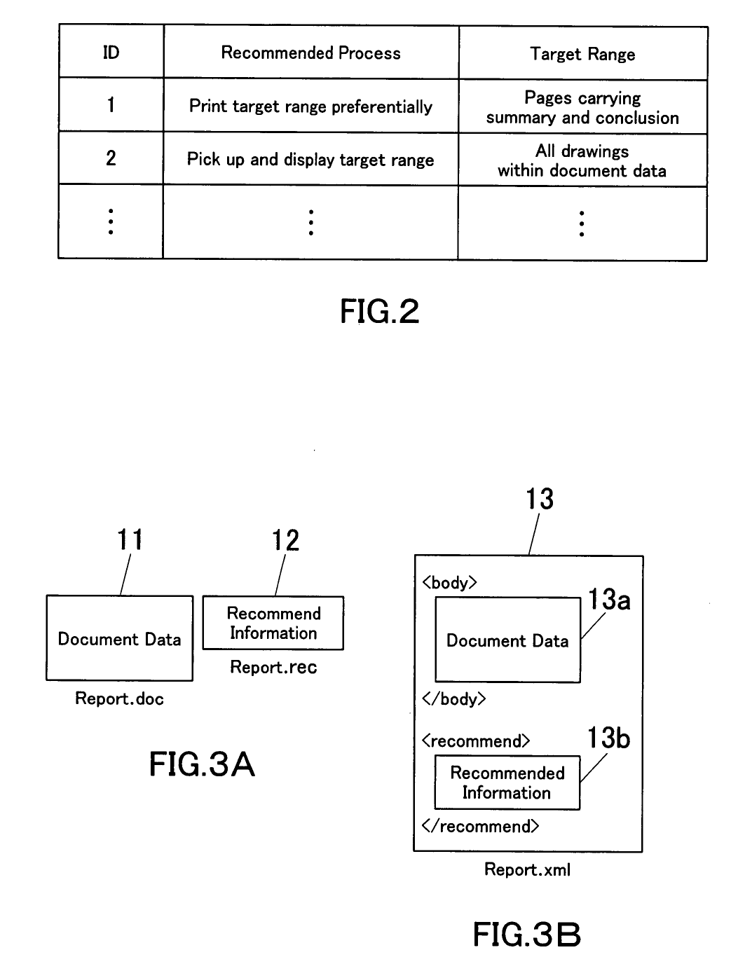

FIG. 2 shows examples of recommend information to be given to document data. Each of recommended information includes a set of a recommended process and a target range to be processed within document data. Each of the recommended information has a number given to be identified. As shown in these examples, “pages carrying summary and conclusion” should be referentially printed and “all drawings within document data” should be picked up and displayed on the display 107.

The recommended information processor 116 shown in FIG. 1 performs a specified recommended process on the target range within the received document data, according to the recommended information shown in FIG. 2.

As previously described, the recommend information as exemplified in FIG. 2 is given to document data by the recommended information giver 115, when the document data is transmitted. FIG. 3 shows two examples of a form in which recommend information is given.

FIG. 3 (a) shows an example where recommended information 12 with a file name “Report.rec” for example, which is an independent file from document data 11 with a file name “Report.doc” for example, is given. FIG. 3 (b) shows an example where recommend information 13b is embedded in document data, in other words, given to be a part of a document data file 13. In this example, document data 13a and the recommended information 13b are included in one XML file “Report.xml”, and start and end of the document data 13a are indicated by a <body> tag and a </body> tag, respectively. Further, start and end of the recommended information 13b are indicated by a<recommend> tag and a</recommend> tag, respectively.

Further, as shown in FIG. 3 (b), recommended information are collectively given to one place within the document data. However, those can be given in parts by tags to target places within the document data, on which recommended processes are performed.

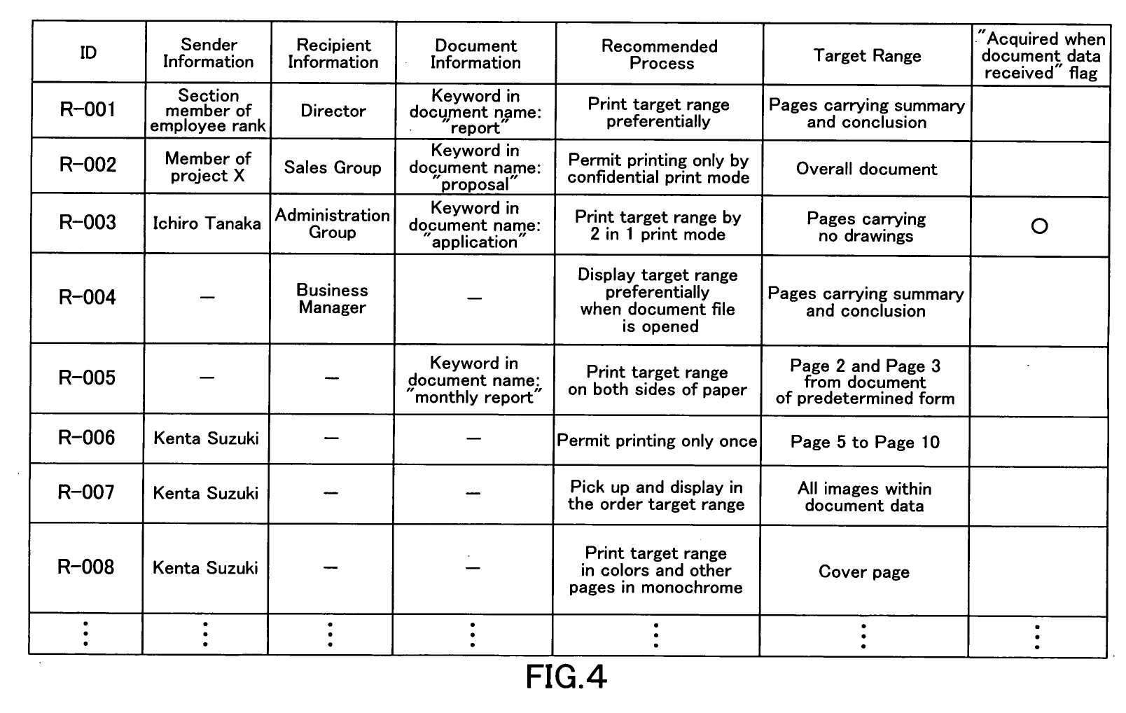

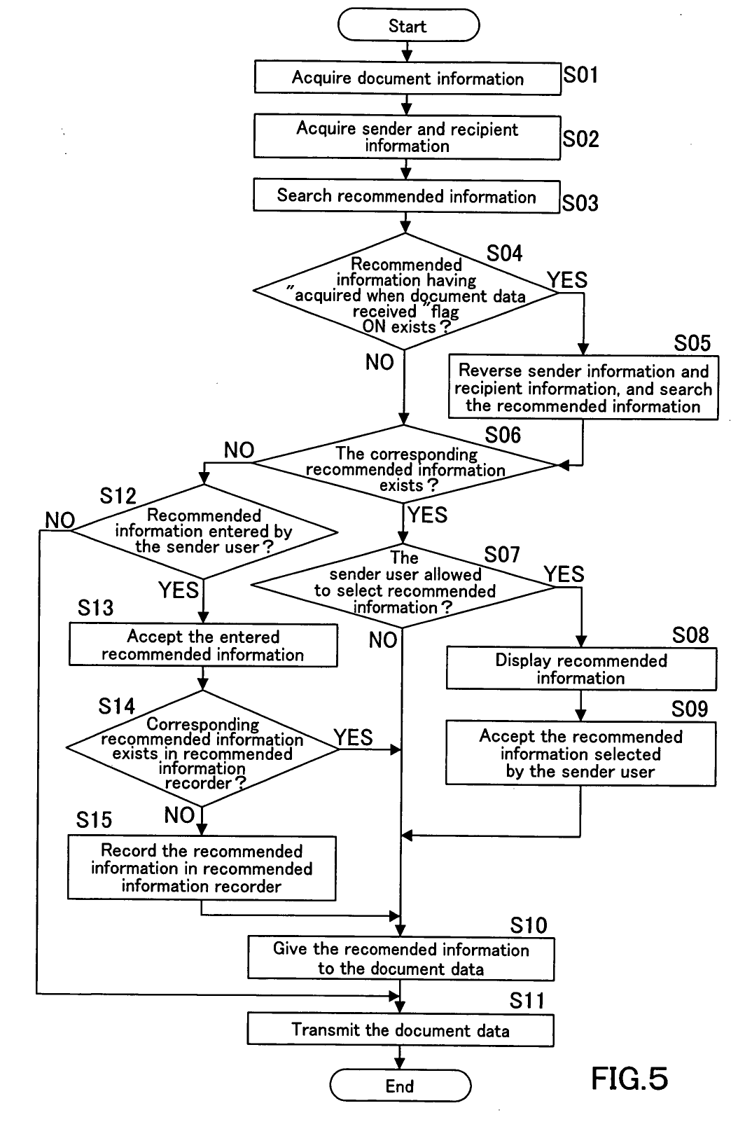

FIG. 4 shows a form in which recommended information is recorded in the recommended information recorder 112. Sender information that is attribute information of sender user, recipient information that is attribute information of recipient user, and document information that is attribute information of document data, besides a recommended process and a target range shown in FIG. 2, are related to become one set of recommended information, and it is recorded with an ID to be identified.

As shown in FIG. 4, there are sender information such as section, title and user name, and recipient information such as title and section. And there are document information such as “report”, “proposal”, “application” and “monthly report” that are keywords included in respective document names. When document data is transmitted, the recommended information selector 114 acquires attribute information of sender user, recipient user and document data, and then selects recommended information having the corresponding respective attribute information, from those recorded in the recommended information recorder 112.

Further, according to the recommended process of recommended information with an ID “R-001” shown in FIG. 4, the target range (pages carrying summary and conclusion) should be preferentially printed. In this way, the pages carrying summary and conclusion are preferentially printed or displayed, and a recipient user can obtain the pages printed without user instructions to search and print, and also can print other pages if need. Thus, he/she does not have to print the overall document unnecessarily.

According to the recommended process of recommended information with an ID “R-002”, a printing condition is set. Specifically, printing only by confidential print mode is permitted. By specifying the printing condition, a recipient user can print a confidential document only by confidential print mode, which avoids a risk that outputted paper is left forgotten and ensures security.

According to the recommended process of recommended information with an ID “R-003”, print setting information to print the target range is set. Specifically, the target range should be printed by 2 in 1 print mode, which two pages are collectively printed in one page. If the target range contains text only, it can be printed in the reduced number of pages by 2 in 1 print mode appropriately. However, if the target range contains drawings, it is printed by 2 in 1 print mode, possibly with too small size of drawings. Thus, only pages carrying no drawings are set as the target range.

According to the recommended process of recommended information with an ID “R-004”, the target range (pages carrying summary and conclusion) should be preferentially displayed when a document file is opened. In this way, a recipient user can display in the first screen the pages carrying summary and conclusion when opening a document file, without user instructions to search and display the pages.

According to the recommended process of recommended information with an ID “R-005”, print setting information to print the target range is set. Specifically, the target range should be printed on both sides of paper. In this way, a recipient user can obtain outputted paper always in the same format without user instruction page by page, if the document is of a predetermined form.

According to the recommended process of recommended information with an ID “R-006”, a printing condition is set. Specifically, the target range is permitted to be printed only once. In this way, a sender user sets the permitted number of printing times, and thereby unexpected security trouble supposedly caused by document transfer can be avoided.

According to the recommended process of recommended information with an ID “R-007”, the target range should be preferentially displayed. Specifically, the target range (all images from document data) should be picked up and displayed in the order. In this way, only necessary parts can be displayed according to user's purpose, and a document can be browsed efficiently.

According to the recommended process of recommended information with an ID “R-008”, the target range should be printed by a specific print mode. Specifically, only the target range (cover page) should be printed in colors, and the other pages should be printed in monochrome. In this way, color print, which costs comparatively much, can be applied only to pages that are necessarily printed in colors.

Further, as shown in FIG. 4, there is a field to put an “acquired when document data received” flag for respective recommended information, and the flag indicates that the recommended information is the one transmitted from an external device, in other words, the recommended information is the one acquired when document data is received and not the one registered by a user in the recommended information recorder 112 at the same time. If it the recommended information is the one acquired when document data is received, a mark “∘” is entered in this field to indicate the flag is ON.

Meanwhile, attribute information of sender user, recipient user and document data are not limited to those exemplified in FIG. 4. For example, a name, etc. of the sender apparatus and the receiver apparatus can be set as attribute information of sender user and receiver user, respectively. Further, date and time of transmission, destination range of document data, day of regular transmission processing of document data, etc. can be set in another field as attribute information of document data. With this setting, recommended information having corresponding date and time of transmission performed by a sender user can be selected.

Further, recommended information having all that correspond to attribute information of sender user, recipient user and document data can be selected or recommended information having at least one that corresponds to any of the attribute information above can be selected.

FIG. 5 is a flowchart showing a procedure executed by the image data processing apparatus when document data is transmitted. The procedure is executed by the CPU 120 according to a program recorded in the program recorder 121.

First, when a sender user enters authentication information from the entry operation part 108, authentication is performed by the Authentication Part 109. If the authentication succeeds, the sender user is permitted to use the document data processing apparatus 1.

Next, the sender user specifies document data to be transmitted by making a document read by the Image reader 101 or selecting document data recorded in the Data recorder 102. Further, the sender user enters a destination of the document data from the entry operation part 108.

In Step S01, the recommended information selector 114 acquires attribute information of document data. Attribute information of document data can be acquired based on the information (for example, a keyword from document name, etc.) entered by the sender user from the entry operation part 108, or can be automatically acquired from the document data to be transmitted.

In Step S02, the recommended information selector 114 acquires attribute information of sender user and receiver user. Attribute information of sender user is acquired from the user information recorder 113 based on the authentication information of the sender user, which is entered when authentication is performed. On the other hand, attribute information of recipient user is acquired from the user information recorder 113 based on the destination of the document data, which is entered by the sender user.

In Step S03, it is checked by the recommended information selector 114 whether or not there is in the recommended information recorder 112, recommended information having corresponding attribute information of sender user (sender information), corresponding attribute information of recipient user (recipient information) and corresponding attribute information of document data (document information).

In Step S04, it is judged whether or not there is in the recommended information recorder 112, recommend information having the “acquired when document data received” flag ON. If there is no recommended information having the flag ON (NO in Step S04), the routine directly proceeds to Step S06. If there is recommended information having the flag ON (YES in Step S04), the sender information and the recipient information are reversed and the corresponding recommended information is searched again in Step S05, and then the routine proceeds to Step S06. The sender information and the recipient information are reversed in Step S05 because recommended information that is registered in the recommended information recorder 112 when document data is received contains the attribute information transmitted from a sender user as is. Therefore, when a recipient user transmits document data as a sender user, sender information and recipient information should be reversed.

In Step S06, it is judged from the searching result by the recommended information selector 114 whether or not there is recommended information having corresponding attribute information of sender user, recipient user and document data.

If there is the corresponding recommended information (YES in Step S06), it is judged by the recommended information selector 114 in Step S07, according to the current setting on the apparatus, whether or not the sender user is allowed to select recommended information. If the sender user is not allowed to select it (NO in Step S07), the routine proceeds to Step S10. If the sender user is allowed to select it (YES in Step S07), recommended information are displayed on the display 107 in Step S08, then the sender user selects recommended information in Step S09, and then the routine proceeds to Step S10.

In Step S10, the recommended information giver 115 gives to the document data, the recommended information selected by the recommended information selector 114, or the recommended information selected by the sender user therefrom. In Step S11, the document data carrying the given recommended information is transmitted to a destination via the communicator 106.

If there is no corresponding recommended information (NO in Step S06), a screen for recommended information entry is displayed on the display 107 and it is judged whether or not recommended information is entered by the user, in Step S06. If recommended information is entered by the user (YES in Step S12), the entered recommended information is accepted in Step S13.

In Step S14, it is judged whether or not there is in the recommended information recorder 112, recommended information that is the same as the entered one. If there is corresponding recommended information (YES in Step S14), the routine proceeds to Step S10. If there is no corresponding recommended information (NO in Step S14), the entered recommended information is registered in the recommended information recorder 112 in Step S15, and then the routine proceeds to Step S10.

If recommended information is not entered by the user (NO in Step S12), the routine directly proceeds to Step S11 where the document data carrying no given recommended information is transmitted to a destination via the communicator 106.

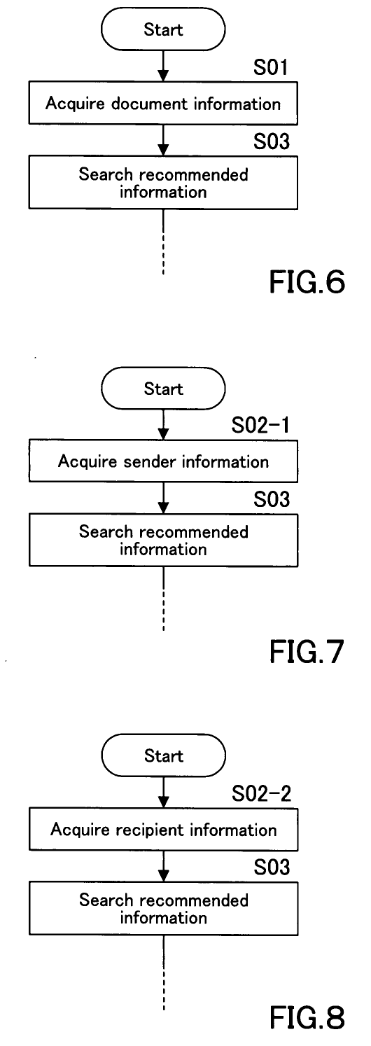

Meanwhile, in the example explained with reference to a flowchart in FIG. 5, all of the attribute information of document data, sender user and receiver user are acquired, and recommended information having corresponding attribute information of those above is searched. However, another procedure can be performed as shown in FIG. 6, wherein only attribute information of document data is acquired and recommended information having corresponding attribute information of document data is searched. For example, if attribute information of document data is “monthly report”, the recommended information with an ID “R-005” in the table shown in FIG. 4 is searched out and given to the document data. In this case, when each of section members sends a monthly report to the section manager, he/she obtains the page 2 and page 3 printed on both sides of paper, and thus can check and file monthly reports from all the section members efficiently.

Further, yet another procedure can be performed as shown in FIG. 7, wherein only attribute information of recipient user is acquired and recommended information having corresponding attribute information is searched. For example, if attribute information of recipient user is “section manager”, the recommended information with an ID “ID R-004” in the table shown in FIG. 4 is searched out and given to the document data. In this case, pages carrying summary and conclusion are preferentially displayed always for a section manager who suffers from receiving large amount of document data, and he/she browses summary and conclusion when document data is received and gives an instruction to print if need, thereby can avoid printing unnecessary documents.

Further, still yet another procedure can be performed as shown in FIG. 8, wherein only attribute information of sender user is acquired and recommended information having corresponding attribute information is searched. For example, if attribute information of sender user is the logged in user (for example, Kenta Suzuki), the recommended information with an ID “R-006” through “R-008” in the table shown in FIG. 4, which are registered by the user, are searched out. Then, the user selects recommended information from those searched out, and the selected recommended information is given to the document data. In this case, a user preliminarily registers a plurality of recommended information as formats to be used frequently, and selects appropriate recommended information among those registered, thereby he/she does not have to make the same setting every time transmits document data.

In the example explained with reference to the flowcharts in FIG. 6 to FIG. 8, only one from the attribute information of sender user, recipient user and document data is acquired and recommended information having corresponding attribute information is searched. However, another procedure can be used wherein two from the attribute information are acquired and recommended information having the corresponding two attribute information is searched.

Meanwhile, in the flowcharts shown in FIG. 6 to FIG. 8, Steps following Step S03 are omitted since those are the same as Steps in the flowchart shown in FIG. 5.

In this embodiment as described above, recommended information having all or at least one that correspond(s) to attribute information of sender user, recipient user and document data, are (is) automatically selected. In this way, a sender user does not have to enter an interest concept about each piece of document data or perform an additional operation anymore, and thus, a document data processing apparatus realizes better user operability and usability.

Further, a plurality of recommended information having corresponding attribute information are displayed on the display 107 so that a sender user can select preferable recommended information therefrom via entry operation part 108. Thus, intention of the sender user can be reflected in selection of recommended information, which contributes to usability.

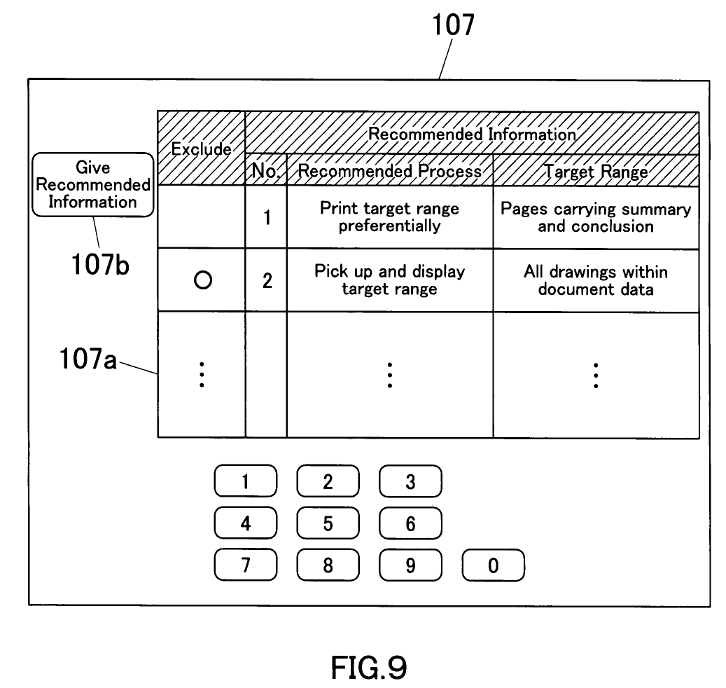

FIG. 9 is a view showing a selection screen displayed on the display 107 when a sender user selects recommended information.

In this example, a plurality of recommended information 107a having corresponding predetermined attribute information, which are searched out by the recommended information selector 114, are displayed. If a sender user presses a “give recommended information” button 107b, all of the displayed recommended information are given to the document data, then the document data is transmitted. If there is recommended information that the sender user does not wish to give to the document data, he/she can exclude it from the recommended information to be given, by touching a “exclude” field to remove a “∘” mark. In this way, the document data is transmitted with the recommended information excluding the one not having the mark.

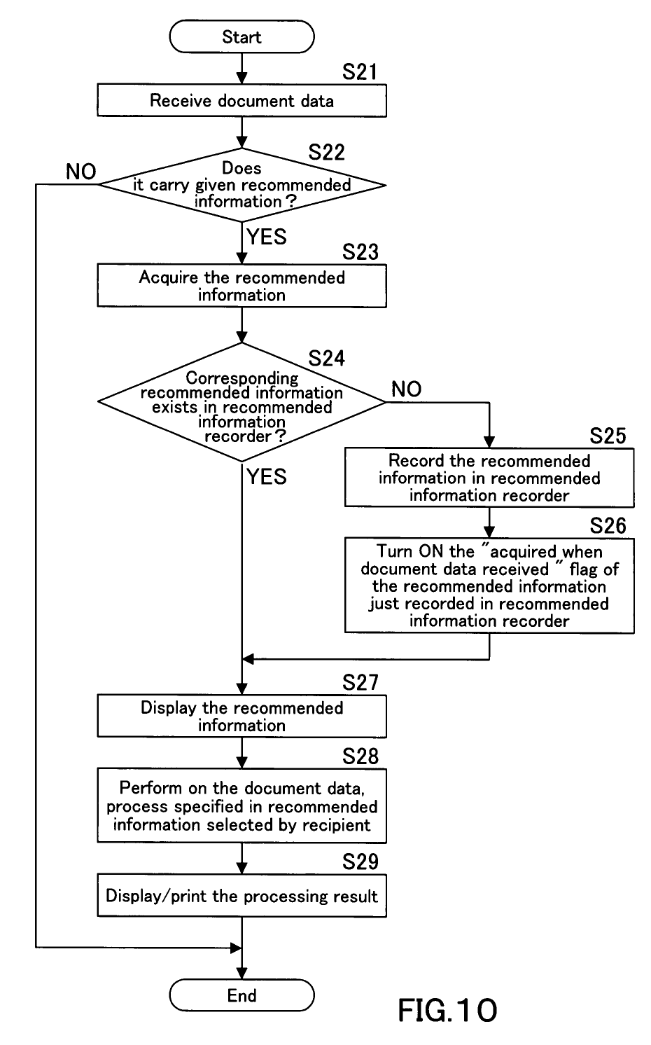

FIG. 10 is a flowchart showing a procedure executed by the document data processing apparatus 1 when document data is received. The procedure is executed by the CPU 120 according to a program recorded in the program recorder 12

First, document data is received via the communicator 106 in Step S21. Then in Step S22, the recommended information processor 116 judges whether or not the received document data carries given recommended information. If it does not carry given recommended information (NO in Step S22), the routine directly terminates, and then the document data is displayed or printed in the ordinary way.

If the received document data carries given recommended information (YES in Step S22), then in Step S23, the recommended information processor 116 acquires the given recommended information, and transfers it to the recommended information registration part 111. And then in Step S24, the recommended information registration part 111 judges whether or not there is the same recommended information registered in the recommended information recorder 112.

If there is the same recommended information registered in the recommended information recorder 112 (YES in Step S24), the routine proceeds to Step S27. If there is not the same recommended information registered (NO in Step S24), then the recommended information registration part 111 registers the recommended information acquired in Step S23 into the recommended information recorder 112 in Step S25, and then the “acquired when document data received” flag of the registered recommended information is turned ON in Step S26. As previously described, the flag will be used in Step S04 of the flowchart shown in FIG. 5. Then, the routine proceeds to Step S27.

In Step S27, the recommended information processor 116 displays on the display 107 the received recommended information so that a recipient user can select preferable recommended information therefrom. Alternatively, the recommended information processor 116 automatically performs a process specified in the recommended information or automatically selects recommended information without user operation to select.

In Step S28, a process specified in the recommended information selected by the recipient user is performed on the document data. Then in Step S29, the processing result is displayed on the display 107 or printed by the image-forming printer 103. For example, pages carrying summary and conclusion within the document data are preferentially displayed or printed, or a predetermined target range is printed according to a predetermined print mode.

As described in this embodiment above, when document data carrying given recommended information is received, the document data is displayed or printed according to an output operation specified in the recommended information. Thus, the recipient user does not have to perform manual operations to select or pick up key point of the transmitted document to obtain them displayed or printed, which greatly contributes to usability.

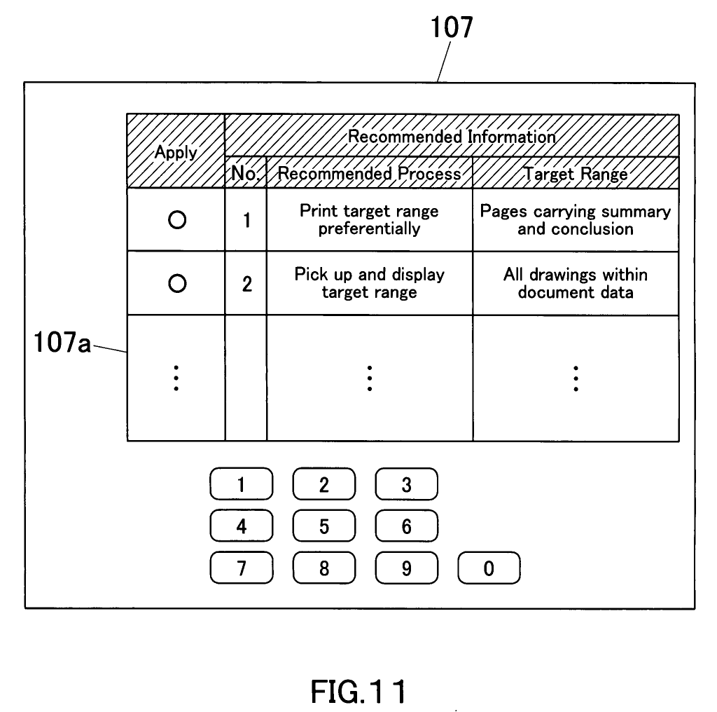

FIG. 11 is a selection screen displayed on the display 107 when a recipient user selects recommended information from those received.

In this example, the plurality of received recommended information 107a are displayed. If there is in the screen, any recommended information that is wished to be excluded from the candidates, it can be excluded from the candidates by touching an “apply” field to remove the “∘” mark. Meanwhile, a plurality of recommended information can be selected as shown in FIG. 11.

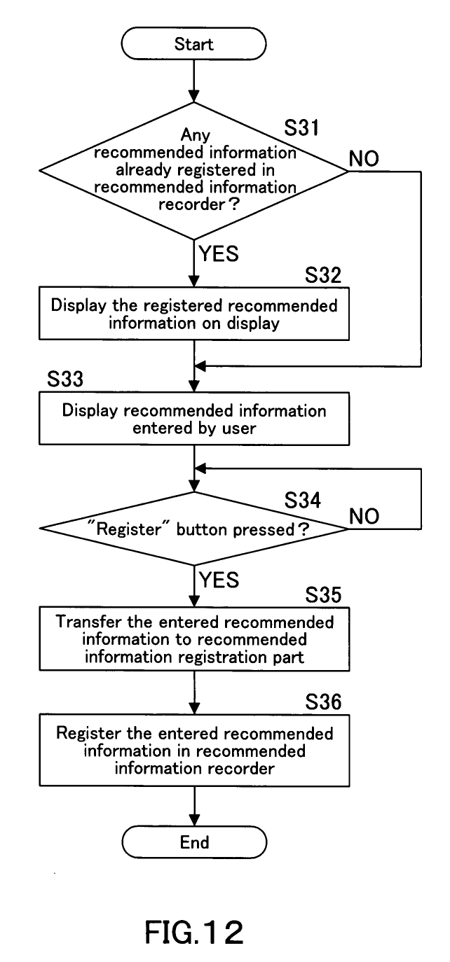

FIG. 12 is a flowchart showing a procedure executed by the document data processing apparatus 1 when a user registers recommended information in the recommended information recorder 112.

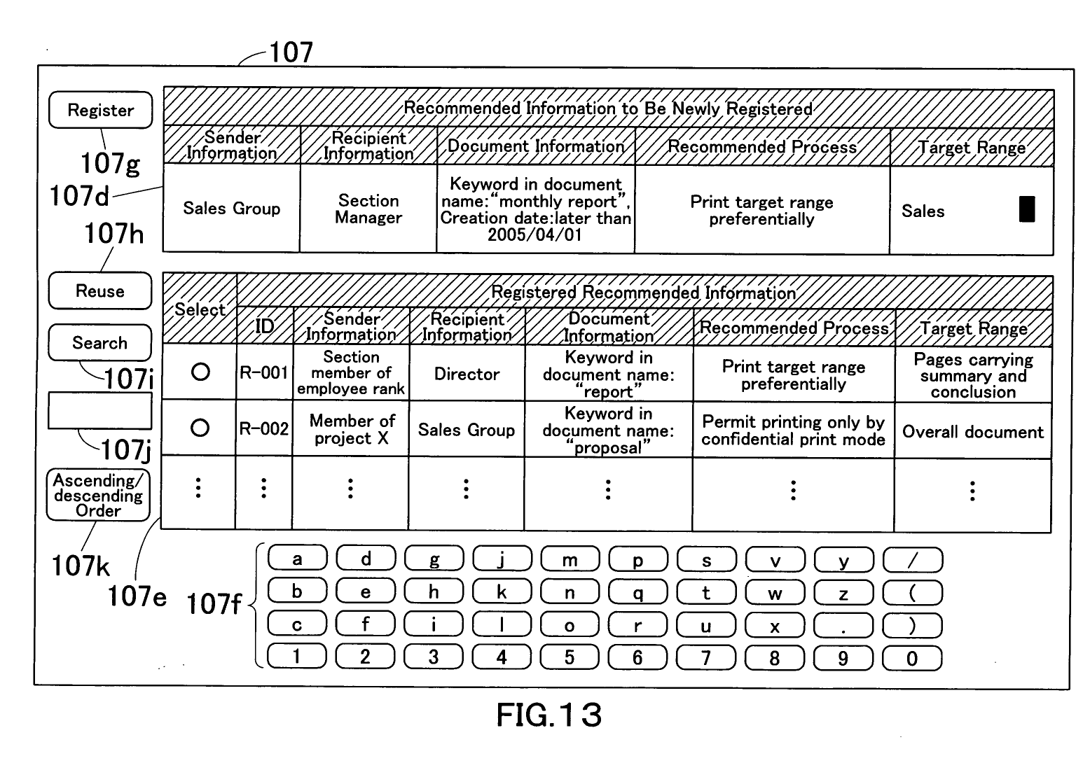

When a user selects a screen to register recommended information via the entry operation part 108 in the document data processing apparatus 1, it is judged in Step S31 whether or not there is any recommended information already registered in the recommended information recorder 112. If there is recommended information already registered therein (YES in Step S31), registered recommended information 107e are displayed on the display 107 as shown in FIG. 13, in Step S32. Then the routine proceeds to Step S33. If there is no recommended information already registered therein (NO in Step S31), the routine directly proceeds to Step S33.

With reference to the displayed recommended information, the user enters recommended information from the entry operation part 108 to register newly. Then in Step S33, the entered recommended information 107d (shown in FIG. 13) is displayed on the display 107.

Subsequently, in Step S34, the routine waits until a “register” button 107g pressed, and if it is pressed (YES in Step S34), the entered recommended information is transferred to the recommended information registration part 111 in Step S35, and the transferred recommended information is registered in the recommended information recorder 112 in Step S36.

In the example in FIG. 12, recommended information is registered via the entry operation part 108 in the document data processing apparatus 1. However, another configuration can be used wherein recommended information entered via a display screen or a key board of an external device such as a personal computer, is received by the document data processing apparatus 1 via the communicator, and transferred to the recommended information registration part 111, and then registered in the recommended information recorder 112.

As shown in a display screen in FIG. 13, the “target range” field of a new recommended information 107d is tried to be filled in (the black mark indicates a cursor position). According to the new recommended information, sender information and recipient information are already selected from attribute information of users, and document data should carry a keyword “monthly report” in document name and it was created later than 2005, 4 Jan. Further, a recommended process is specified in the new recommended information, wherein a target range should be preferentially printed.

On the other hand, already registered recommended information 107e are displayed right under the registration field. A user touches a “select” field to select preferable recommended information from the registered recommended information 107e, and presses a “reuse” button 107h to copy the selected recommended information to the registration field above, and thus he/she can edit and reuse it, which improves user operability.

There are a “search” button 107i and a search word entry field 107j to search and refer to registered recommended information. In addition, there is an “ascending/descending order” button key 107k to switch the listing order of the registered recommended information 107e. The code 107f indicates a keyboard to enter and edit recommended information.

One embodiment of the present invention has been explained so far, however, the present invention is not limited to the embodiment above. For example, a recommended process specified in recommended information indicates that a specific part within document data should be printed or displayed preferentially, or a specific part within document data should be printed by a specific print mode. Alternatively, a recommended process can be any one that relates to an output operation of document data such as resolution conversion, file format conversion, or file merger. Further, the output operation can be not only displaying or printing, but also transmission to another destination or other operation.

Further, in this embodiment, the recommended information recorder 112, the user information recorder 113 and the authentication part 109 are provided inside of the document data processing apparatus 1. However, at least one of those can be provided in an external device such as an external server, and the document data processing apparatus 1 communicates with the recommended information recorder 112, the user information recorder 113 and the authentication part 109, in order to enable the functions thereof.

Further, in this embodiment, the document data processing apparatus 1 is an image forming apparatus. However, it can be any device that is able to give recommended information to document data and perform a process specified therein when sending/receiving document data.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A document data processing apparatus, comprising:
an attribute information acquirer that acquires attribute information of sender or recipient;
a recommended information giver that gives recommended information to recommend an output operation to document data to be transmitted, based on said acquired attribute information; and
a transmitter that transmits said document data carrying the given recommended information.

2. A document data processing apparatus, comprising:
an attribute information acquirer that acquires attribute information of document data to be transmitted;
a recommended information giver that gives recommended information to recommend an output operation to the document data to be transmitted, based on said acquired attribute information; and
a transmitter that transmits said document data carrying the given recommended information.

3. The document data processing apparatus as recited in claim 1, further comprising:
a recommended information recorder that holds recorded recommended information that is related to the attribute information of sender or recipient, wherein:
said recommended information giver selects recommended information from said recommended information recorded in the recommended information recorder, based on the acquired attribute information of sender or recipient.

4. The document data processing apparatus as recited in claim 2, further comprising:
a recommended information recorder that holds recorded recommended information that is related to the attribute information of document data, wherein:
said recommended information giver selects recommended information from said recommended information recorded in the recommended information recorder, based on the acquired attribute information of document data.

5. The document data processing apparatus as recited in claim 1, wherein:
said recommended information giver selects recommended information from the recommended information that are related to the attribute information of sender or recipient and are recorded in the recommended information recorder that is externally provided, based on the acquired attribute information of sender or recipient.

6. The document data processing apparatus as recited in claim 2, wherein:
said recommended information giver selects recommended information from the recommended information that are related to the attribute information of document data and are recorded in the recommended information recorder that is externally provided, based on the acquired attribute information of document data.

7. The document data processing apparatus as recited in claim 1, wherein:
said recommended information indicates a target range within the document data to be transmitted, which is to be preferentially printed or displayed.

8. The document data processing apparatus as recited in claim 2, wherein:
said recommended information indicates a target range within the document data to be transmitted, which is to be preferentially printed or displayed.

9. The document data processing apparatus as recited in claim 1, wherein:
said recommended information indicates a print setting for the target range within the document data to be transmitted.

10. The document data processing apparatus as recited in claim 2, wherein:
said recommended information indicates a print setting for the target range within the document data to be transmitted.

11. The document data processing apparatus as recited in claim 1, wherein:
said recommended information indicates a print condition for the document data to be transmitted.

12. The document data processing apparatus as recited in claim 2, wherein:
said recommended information indicates a print condition for the document data to be transmitted.

13. The document data processing apparatus as recited in claim 1, wherein:
said recommended information giver gives the recommended information by embedding it in said document data, or gives the recommended information that is independent from said document data by attaching it to said document data.

14. The document data processing apparatus as recited in claim 2, wherein:
said recommended information giver gives the recommended information by embedding it in said document data, or gives the recommended information that is independent from said document data by attaching it to said document data.

15. The document data processing apparatus as recited in claim 1, further comprising:
a display that displays recommended information to be given to the document data; and
a selection part that enables a sender to select preferable recommended information from the plurality of recommended information displayed on said display.

16. The document data processing apparatus as recited in claim 2, further comprising:
a display that displays recommended information to be given to the document data; and
a selection part that enables a sender to select preferable recommended information from the plurality of recommended information displayed on said display.

17. The document data processing apparatus as recited in claim 3, further comprising:
a recommended information registration/edit part that registers recommended information in said recommended information recorder or changes recommended information registered therein.

18. A document data processing apparatus, comprising:
a receiver that receives document data carrying recommended information to recommend an output operation, and the recommended information is given based on attribute information of sender or recipient;
an output part that outputs said received document data; and
an output controller that controls an output operation performed by said output part, according to said recommended information given to the document data.

19. A document data processing apparatus, comprising:
a receiver that receives document data carrying recommended information to recommend an output operation, and the recommended information is given based on attribute information of sender or recipient;
an output part that outputs said received document data; and
an output controller that controls an output operation performed by said output part, according to said recommended information given to the document data.

20. The document data processing apparatus as recited in claim 18, further comprising:
a selection part that enables a recipient to select preferable recommended information if there are a plurality of given recommended information.

21. The document data processing apparatus as recited in claim 19, further comprising:
a selection part that enables a recipient to select preferable recommended information if there are a plurality of given recommended information.

22. The document data processing apparatus as recited in claim 18, further comprising:
a recommended information registration part that compares the given recommended information received with the document data to the recommended information recorded in the recommended information recorder, then registers said received recommended information in the recommended information recorder if there is in the recommended information registration part no recommended information that is the same as received one.

23. The document data processing apparatus as recited in claim 19, further comprising:
a recommended information registration part that compares the given recommended information received with the document data to the recommended information recorded in the recommended information recorder, then registers said received recommended information in the recommended information recorder if there is in the recommended information registration part no recommended information that is the same as received one.

24. A recording medium having therein a recorded document data processing program to make a computer execute:
acquiring attribute information of sender or recipient;
giving recommended information to recommend an output operation to document data to be transmitted, based on said acquired attribute information; and
transmitting said document data carrying the given recommended information.

25. A recording medium having therein a recorded document data processing program to make a computer execute:
acquiring attribute information of document data to be transmitted;
giving recommended information to recommend an output operation to document data to be transmitted, based on said acquired attribute information; and
transmitting said document data carrying the given recommended information.

26. A recording medium having therein a recorded document data processing program to make a computer execute:
receiving document data carrying recommended information to recommend an output operation, and the recommended information is given based on attribute information of sender or recipient;
outputting said received document data; and
controlling an output operation to output said document data, according to said recommended information given to the document data.

27. A recording medium having therein a recorded document data processing program to make a computer execute:
receiving document data carrying recommended information to recommend an output operation, and the recommended information is given based on attribute information of document data;
outputting said received document data; and
controlling an output operation to output said document data, according to said recommended information given to the document data.
